(19) United States
(12) Patent Application Publication
(10) Pub. No.: US 2018/0148034 A1
(43) Pub. Date: May 31, 2018

(54) DEVICE AND METHOD FOR CONTROLLING A PROPULSION EFFECT OF A SHIP

(71) Applicant: Lean Marine Sweden AB, Göteborg (SE)

(72) Inventor: Linus Ideskog, Öckerö (SE)

(73) Assignee: Lean Marine Sweden AB, Göteborg (SE)

(21) Appl. No.: 15/575,221

(22) PCT Filed: May 20, 2016
(86) PCT No.: PCT/SE2016/050464

§ 371 Date: Nov. 17, 2017

(30) Foreign Application Priority Data
May 20, 2015 (SE) 1500240-5

(51) Int. Cl. B60W 10/04; G01C 21/20; B63H 21/21; B63H 21/22; F02D 29/02

(52) U.S. Cl. CPC B60W 10/04; G01C 21/203; F02D 29/02; B63H 21/22; B63H 21/21

(57) ABSTRACT

The invention relates to a method for controlling a propulsion effect of a ship in order to enable efficient fuel consumption. The method includes reading a set point value for speed from a first input device, reading a set point value for fuel consumption from a second input device, and controlling the propulsion effect to a set point value resulting in the lowest fuel consumption.

### TECHNICAL FIELD

The present invention relates to a device for controlling a propulsion effect of a ship according to the preamble of claim 1. Moreover, the present invention relates to a method for controlling a propulsion effect of a ship. Further, the invention relates to a control unit.

### BACKGROUND

Within shipping, the fuel costs are a major part of the total operational costs. In order to save fuel, the current trend is towards “slow steaming” which means that the ships are operated at a lower speed and at a lower effect than the design condition. The trend is also towards the shipowner's seeking better control of the operation of the ships.

The invention presented herein presents a solution that on one hand allows a requested speed being defined in order to reach the destination in the right time, at the same time as it is possible to automatically limit the maximum consumption when weather or load conditions are such that the requested speed cannot be kept.

### STATE OF THE ART

Systems which control a constant speed for a ship have been marketed for many years, usually as a part of complex dynamic positioning systems, “DP systems”. These allow that a speed, from stationary to full speed, and a position may be set with great accuracy. The systems are very expensive and require additional propellers.

On the market, so called ETA systems (ETA pilot) also exist, which calculate which speed the ship needs to keep in order to arrive at a determined time. Often, these are connected to a navigation system wherein a course and speed may be set for each leg of the current route. The ETA system then controls the ship's speed via the control system for the main propellers.

Simpler systems by which it is only possible to control the speed of the boat within a normal speed range, without any connection to the navigation system, seem not to be commercially available.

Systems measuring the fuel consumption and presenting it to the crew are common, but systems for controlling towards a determined consumption also appear not to be commercially available.

### SUMMARY OF THE INVENTION

The purpose of the invention described herein is to facilitate the operation of ships, having a fixed or adjustable propeller, wherein there is a need to take a specific arrival time into account, at the same time as it is desired to avoid that the fuel consumption exceeds an acceptable value. The uniqueness of the invention is that it at the same time, via separate input devices, allows the crew, and/or the shipowner, to determine a requested speed and a requested consumption, and thereafter controls the ship's propulsion effect towards the entity which results in the lowest fuel consumption.

The current set point value may be determined from navigation data and calculations of maximum costs of the freight.

The invention is achieved such that there are two separate set point values, one for desired speed and one for maximum consumption. The selection of which set point value that will apply is made by comparing the actual consumption to the set point value for the maximum consumption. If the actual consumption is higher than or equal to the maximum consumption, the ship's propulsion effect is controlled based on consumption. If the actual effect is lower than the requested maximum consumption, the propulsion effect is controlled such that the requested speed is maintained.

The output signal from the device according to the invention is a set point value to the ship's propulsion system. The set point value effects, directly or indirectly, the propulsion effect of the ship.

Varying propulsion force and speed results in a higher total consumption for a voyage. By automatic control of the propulsion force, for instance by means of the invention presented above, unnecessary effect peaks may also be avoided for instance during poor sea conditions.

### BRIEF DESCRIPTION OF THE DRAWINGS

FIG. 1 A typical control panel

FIG. 2 Diagram of control logic

FIG. 3 Block diagram of an embodiment.

### DETAILED DESCRIPTION OF PREFERRED EMBODIMENTS

In a general situation, the functions are realized by a microprocessor based control system (3). The example discloses a system with a fixed propeller, although independent of the ship's propulsion principle, the system may be realized in the same manner.

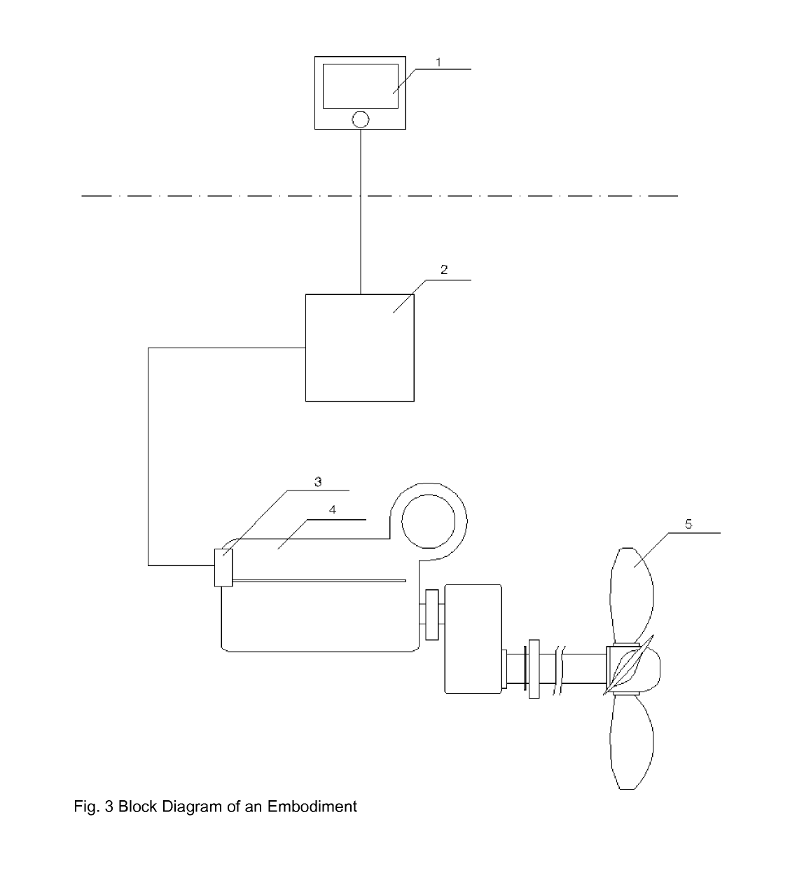

FIG. 3
3.1 User board
3.2 Electronic unit
3.3 Engine speed regulator of the main engine
3.4 Main engine
3.5 Propeller

The system is served from the bridge user board 3.1. From this, a requested speed and fuel consumption may be fed into the system. The user board further comprises indicators and control units for reading actual values and set point values as well as activating and deactivating the system. The requested set point values for desired speed and maximum consumption are sent to the electronic unit 3.2, which compares them to the actual read values. The choice between which one of the regulators that is used, speed or consumption, is made by comparing the actual consumption to the set maximum consumption.

The actual fuel consumption may be measured by measurement techniques such as those using displacement flow sensors or mass flow sensors. The fuel consumption may also be obtained from an estimated consumption based on a calculation from other sensors such as fuel pump displacement and rotational speed. The calculation may also be based on the current effect assuming a certain consumption of the main engine. The power output may be estimated by pump rod position, top pressure measurement or measurement of torque together with engine speed.

The propulsion effect corresponds to the propeller 3.5 effect and is controlled by the output signal from the active regulator being sent to the main engines engine's speed regulator.

The electronic unit 3.2, or the control unit, may be part of, and even constitute, a device for controlling the propulsion effect of a ship. The device may control the propulsion effect by sending a signal to the engine speed regulator which in turn controls the engine speed of the main engine 3.4.

As a non-limiting example, the control of the propulsion effect may be based on control of a shaft effect wherein desired shaft effect is a set point value, for instance the set point value may be given in fixed predefined steps, optionally the set point value may be continuously variable. The actual value is given by a shaft effect or an estimated effect of the shaft.

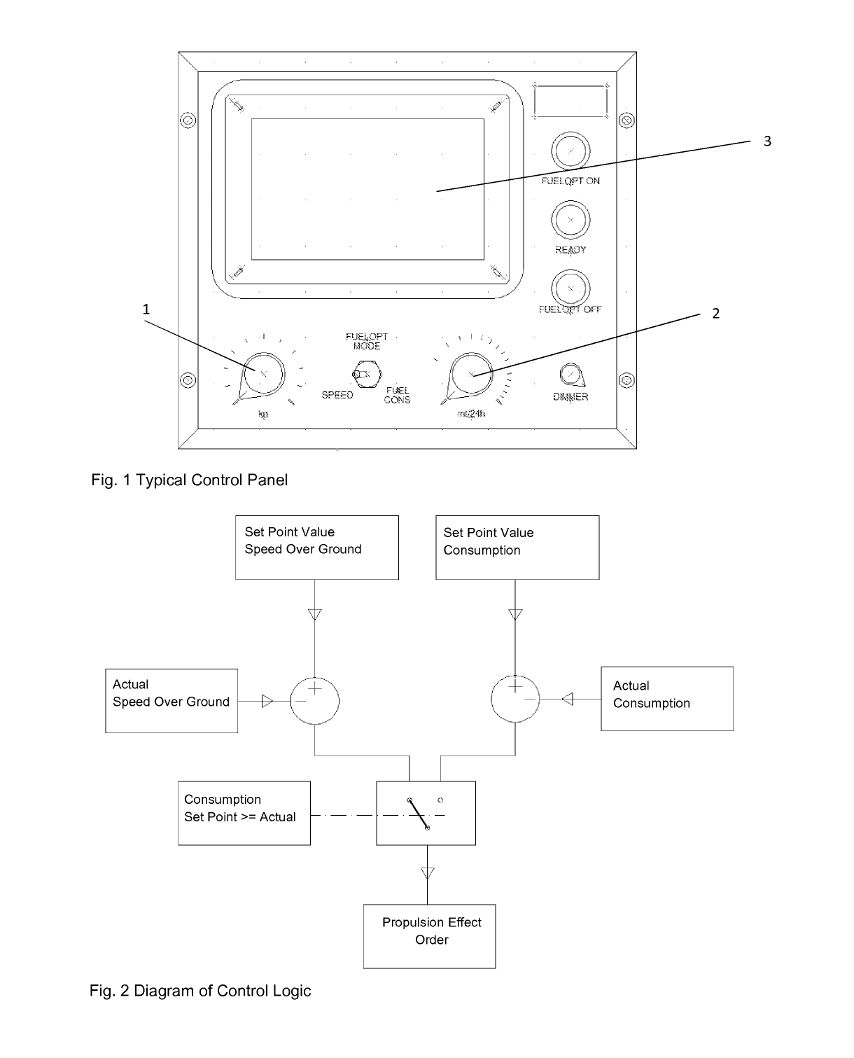

For instance, the electronic unit 3.2, or the control unit, may comprise control logic such as the control logic illustrated in FIG. 2.

The set point value for speed may be input via a first regulator 1, or a first input device, as illustrated in FIG. 1. In a similar manner, FIG. 1 illustrates a second regulator 2, or a second input device, by which the set point value for maximum fuel consumption, that is maximum allowed fuel consumption, may be inputted. The regulators 1,2 are in FIG. 1 illustrated as knobs that may be turned in order to set the respective set point value. The regulators may also be designed in other ways, for instance as levers, touch screens or other types of controls. Independent of how the controls are designed, it is preferred if the controls allow the two set point values, that is the set point values for speed and fuel consumption, respectively, to be inputted separately.

The invention also relates to a method for controlling a propulsion effect of a ship. The method comprises reading a set point value for speed from a first regulator; reading a set point value for fuel consumption from a second regulator and controlling the propulsion effect to the set point value resulting in the lowest fuel consumption.

Optionally, the method may further comprise comparing the actual fuel consumption obtained by control to the set point value for speed to the actual fuel consumption obtained by control to the set point value for fuel consumption.

The invention may be exemplified according any one of the below points.

A device for controlling the propulsion effect of a ship, characterized in that the input is made by 2 separate set point values, requested speed and maximum fuel consumption, and that control is made to the entity resulting in the lowest fuel consumption.

The device according to point 1, characterized in that the set point value for speed, via a regulator, controls the speed of the ship by controlling the propulsion effect of the ship, wherein control of the propulsion effect can be made directly to the main engine or indirectly via other systems.

The device according to point 1, characterized in that the set point value for fuel consumption, via a regulator, controls the ship's consumption by controlling the propulsion effect of the ship, wherein control of the propulsion effect can be made directly to the main engine or indirectly via other systems.

The device according to points 1, 2 and 3, which may be used for ships with any type of propulsion principle.

Moreover, embodiments of the invention may be described as both the speed and consumption being able to be fed via separate input devices. The speed of the ship being controlled to the desired value as long as the actual fuel consumption is lower than the input maximum fuel consumption. Should this not be the case, the propulsion effect is controlled such that the maximum consumption is not exceeded.

The invention may be used in any type of propulsion system for ships.

1. A device for controlling a propulsion effect of a ship, characterized in that an input is made by two separate set point values, one set point value for speed and one set point value for maximum fuel consumption, and that control is made to the set point value resulting in the lowest fuel consumption.

2. The device according to claim 1, characterized in that the set point value for speed, via a regulator, controls the speed of the ship by controlling the propulsion effect of the ship.

3. Device according to any one of the preceding claims, characterized in that the set point value for fuel consumption, via a regulator, controls the ship's consumption by controlling the propulsion effect of the ship.

4. Device according to claim 2 or 3, characterized in that the control of the propulsion effect may be performed directly via a main machine.

5. Device according to claim 2 or 3, characterized in that the control of the propulsion effect may be performed indirectly via another system.

6. A ship comprising a device according to any one of the preceding claims.

7. A method for controlling a propulsion effect of a ship, the method comprising:
reading a set point value for speed from a first regulator,
reading a set point value for fuel consumption from a second regulator and
controlling the propulsion effect to the set point value resulting in the lowest fuel consumption.

8. The method according to claim 7, wherein the method further comprises comparing the actual fuel consumption obtained by control to the set point value for speed to the actual fuel consumption obtained by control to the set point value for fuel consumption.

9. A control unit, preferably an electronic control unit, adapted to perform all the steps of a method according to any one of claim 7 or 8.
